(19) United States
(12) Patent Application Publication
(10) Pub. No.: US 2023/0261318 A1
(43) Pub. Date: Aug. 17, 2023

(54) ENERGY STORAGE DEVICE

(71) Applicant: POLYBATT MATERIAL CO., LTD., Tainan City (TW)

(72) Inventors: PING-LIN KUO, Tainan City (TW); CHIH-HAO TSAO, Tainan City (TW); SHUN-YUAN HSU, Tainan City (TW)

(21) Appl. No.: 18/110,871

(22) Filed: Feb. 16, 2023

(30) Foreign Application Priority Data
Feb. 17, 2022 (TW) 111105802

(51) Int. Cl. H01M 50/44; H01M 50/46; H01M 50/42; H01M 50/446; H01M 50/403; H01M 10/0565; H01M 10/052

(52) U.S. Cl. CPC H01M 50/44; H01M 50/46; H01M 50/42; H01M 50/446; H01M 50/403; H01M 10/0565; H01M 10/052; H01M 2300/0082; H01M 2300/0085

(57) ABSTRACT

The disclosure provides an energy storage device, comprising: an anode; a cathode; a separator, which is located between the anode and the cathode; an electrolyte, which is disposed between the anode and the cathode, and cladded on the separator; wherein, the separator is a fibrous membrane composed of polyacrylonitrile, and a surface of the fibrous membrane is modified by an acidic functional group or a salt thereof. The energy storage device of the disclosure can be applied to the technical field of lithium batteries.

### CROSS-REFERENCE TO RELATED APPLICATION

This non-provisional application claims priority under 35 U.S.C. § 119(a) on Patent Application No(s). 111105802 filed in Taiwan, R.O.C. on Feb. 17, 2022, the entire contents of which are hereby incorporated by reference.

### BACKGROUND OF THE INVENTION

### 1. Field of the Invention

The present disclosure relates to an energy storage device, and in particular to an energy storage device, a separator thereof is a fibrous membrane composed of polyacrylonitrile, and a surface of the fibrous membrane is modified by an acidic functional group or a salt thereof.

### 2. Description of the Related Art

Energy storage devices are widely used in various electronic products. The physical and chemical properties of the separator used in the energy storage device have a certain degree of influence on the charge and discharge performance of the energy storage device. Thus, it is the goal of a person having ordinarily knowledge in the art of the present disclosure to know how to select the material of the separator, and how to modify the chemical structure of the surface of the separator, thereby improving the charge and discharge performance of the energy storage device.

In the prior art of energy storage devices, there is a use of polymers containing tetrafluoroethylene segments as a separator, however, there is still room for progress of the polymers containing tetrafluoroethylene segments in improving the charge and discharge performance of the energy storage device.

### BRIEF SUMMARY OF THE INVENTION

There is still room for progress of the separator used by energy storage devices in the prior art in improving the charge and discharge performance of energy storage devices.

To achieve the above object and other objects, the disclosure provides an energy storage device, comprising: an anode; a cathode; a separator, which is located between the anode and the cathode; an electrolyte, which is disposed between the anode and the cathode, and cladded on the separator; wherein, the separator is a fibrous membrane composed of polyacrylonitrile, and a surface of the fibrous membrane is modified by an acidic functional group or a salt thereof.

In the above-mentioned energy storage device, the acidic functional group may be selected from the group consisting of carboxylic acid group (—COOH), sulfonic acid group (—SO₃H), sulfuric acid group (—OSO₃H), phosphoric acid group (—OPO₃H₂), phosphorous acid group (—PO₃H₂) and carbonic acid group (—OCO₂H).

In the above-mentioned energy storage device, the salt may be selected from the group consisting of lithium salt, sodium salt, potassium salt, magnesium salt, calcium salt, aluminum salt and quaternary ammonium salt.

In the above-mentioned energy storage device, the fibrous membrane may be obtained by an electrospinning process or a meltblown process.

In the above-mentioned energy storage device, the electrolyte may be a liquid, gel or solid substance that can conduct lithium ions.

In the above-mentioned energy storage device, the electrolyte may be a gel substance that can conduct lithium ions, and the gel substance may be derived from a gel polymer electrolyte precursor solution, the gel polymer electrolyte precursor solution may comprises: a multi-functional methacrylate crosslinker, a poly (ethylene glycol)-based methacrylate, and an azo-type initiator or a peroxide-type initiator.

In the above-mentioned energy storage device, the azo-type initiator may be selected from the group consisting of 2,2′-Azobisisobutyronitrile (AIBN), 2,2′-Azobis(2,4-dimethyl)valeronitrile (ADVN), 2,2′-Azobis-(2-methybutyronitrile) (AMBN), and 4,4-Azobis(4-cyanovaleric acid) (ACVA).

In the above-mentioned energy storage device, the multi-functional methacrylate crosslinker may be synthetic dimethacrylate (SDMA) with acrylic groups at two ends.

In the above-mentioned energy storage device, the poly (ethylene glycol)-based methacrylate may be a poly (ethylene glycol)-based mono-functional methacrylate or a poly (ethylene glycol)-based multi-functional methacrylate, more specifically may be poly (ethylene glycol) methyl ether methacrylate (PEGMEMA).

In the above-mentioned energy storage device, the gel polymer electrolyte precursor solution may further comprises: lithium salts.

In the above-mentioned energy storage device, the electrolyte may be a solid substance that can conduct lithium ions, and the separator may cladded in the solid substance to form a solid polymer electrolyte.

In the above-mentioned energy storage device, the solid substance may formed by a mixture of poly(ethylene oxide) (PEO) and lithium salts after solidification.

The energy storage device of the present disclosure can have preferable battery performance and cycle life by a special separator.

### BRIEF DESCRIPTION OF THE DRAWINGS

FIG. 1 is the surface modification process of Preparation example 2.

FIG. 2 is the preparation process of Preparation example 4.

FIG. 3 is the preparation process of Example 1.

FIG. 4 is an SEM image of the surface of the PFM fibrous membrane.

FIG. 5 is an SEM image of the cross-section of the PFM fibrous membrane.

FIG. 6 is an SEM image of the surface of the mPFM 5 fibrous membrane.

FIG. 7 is an SEM image of the cross-section of the mPFM 5 fibrous membrane.

FIG. 8 is an SEM image of the surface of the mPFM 15 fibrous membrane.

FIG. 9 is an SEM image of the cross-section of the mPFM 15 fibrous membrane.

FIG. 10 is an SEM image of the surface of the mPFM 30 fibrous membrane.

FIG. 11 is an SEM image of the cross-section of the mPFM 30 fibrous membrane.

FIG. 12 is an SEM image of the surface of the mPFM 60 fibrous membrane.

FIG. 13 is an SEM image of the cross-section of the mPFM 60 fibrous membrane.

FIG. 14 is an SEM image of the surface of the mPFM 120 fibrous membrane.

FIG. 15 is an SEM image of the cross-section of the mPFM 120 fibrous membrane.

FIG. 16 is an SEM image of the surface of the commercial three-layer (PP/PE/PP) porous membrane.

FIG. 17 is an SEM image of the cross-section of the commercial three-layer (PP/PE/PP) porous membrane.

FIG. 18 is a test result of the ionic conductivity of the commercial three-layer (PP/PE/PP) porous membrane, PFM fibrous membrane and mPFM series fibrous membranes.

FIG. 19 is a test result of the ionic conductivity of PNWM solid polymer electrolyte and mPNWM series solid polymer electrolytes.

FIG. 20 is a graph of charge and discharge performance of a liquid lithium battery using mPFM 30 fibrous membrane.

FIG. 21 is a graph of charge and discharge performance of a gel lithium battery using the commercial three-layer (PP/PE/PP) porous membrane.

FIG. 22 is a graph of charge and discharge performance of a gel lithium battery using PFM fibrous membrane.

FIG. 23 is a graph of charge and discharge performance of a gel lithium battery using mPFM 30 fibrous membrane.

FIG. 24 is a graph of charge and discharge performance of a solid lithium battery using PNWM.

FIG. 25 is a graph of charge and discharge performance of a solid lithium battery using mPNWM 5.

FIG. 26 is a graph of charge and discharge performance of a solid lithium battery using mPNWM 10.

FIG. 27 is a graph of charge and discharge performance of a solid lithium battery using mPNWM 15.

FIG. 28 is a graph of charge and discharge performance of a solid lithium battery using mPNWM 30.

FIG. 29 is a test result of 2C cycle life of a gel lithium battery using the commercial three-layer (PP/PE/PP) porous membrane.

FIG. 30 is a test result of 2C cycle life of a gel lithium battery using PFM fibrous membrane.

FIG. 31 is a test result of 2C cycle life of a gel lithium battery using mPFM 30 fibrous membrane.

FIG. 32 is a graph of long-term cyclic charge and discharge of a solid lithium battery using PNWM.

FIG. 33 is a graph of long-term cyclic charge and discharge of a solid lithium battery using mPNWM 15.

FIG. 34 is a graph of charge and discharge performance of a liquid lithium battery using Co-Polymer A.

### DETAILED DESCRIPTION OF THE INVENTION

To facilitate understanding of the object, characteristics and effects of this present disclosure, embodiments for the detailed description of the present disclosure are provided.

### Preparation Example 1: Preparation of the Separator

The energy storage device of the present disclosure comprises a separator that may be an electrospinning fibrous membrane prepared by an electrospinning process, exemplarily illustrating the preparation process as follows.

According to a weight ratio of 88:12, dimethylformamide (DMF) and polyacrylonitrile (PAN) are weighed to prepare a polymer solution, after dissolved evenly, the polymer solution is filled into a syringe barrel for the subsequent electrospinning process. The operating parameters of the electrospinning are set as follows: the voltage provided by the voltage supplier is 22622 V, the distance between the needle tip and the collector is 20 cm, the polymer solution is propelled with a flow rate of 1 ml hr⁻¹, the total volume of the injection is 1.3 ml, and the electrospinning fibrous membrane is collected on a grounded aluminum foil, and then the resulting fibrous membrane is rolled by a rolling machine, the rolling thickness is set to 0.04 mm, and finally the membrane is placed in a vacuum oven at 80° C. for 24 hours to remove the solvent, and the electrospinning fibrous membrane of the present preparation example can be obtained.

It should be understood that the preparation process of the separator of Preparation example 1 is only an example, the present disclosure is not limited thereto. For example, in order to obtain a separator contained in the energy storage device of the present disclosure, a person having ordinarily knowledge in the art of the present disclosure may adjust the parameters of the electrospinning process to prepare the separator as needed, or change to a meltblown process to prepare the separator.

### Preparation Example 2: Surface Modification of the Separator

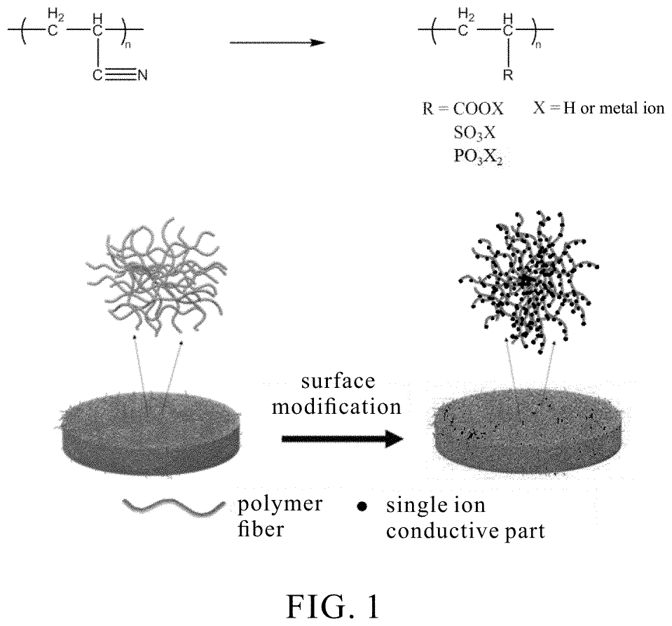

The surface modification process of Preparation example 2 is shown in FIG. 1, the electrospinning fibrous membrane prepared by Preparation example 1 is taken, and a lithium hydroxide aqueous solution is used for surface modification, according to the different modification time, the modification degree of the surface of the electrospinning fibrous membrane can be controlled by the acetic acid functional group, and finally the modified electrospinning fibrous membrane is placed in a vacuum oven at 80° C. for 24 hours, after the solvent is removed, the electrospinning fibrous membrane of different degrees of modification can be obtained. In Preparation example 2, the surface of the fibrous membrane is modified by a carboxylic acid group (—COOH) or lithium salt thereof, but the present disclosure is not limited thereto, a person having ordinarily knowledge in the art of the present disclosure may change to other acidic functional groups or salt thereof to modify the surface as needed, for example: as shown in FIG. 1, the surface of the fibrous membrane may be modified by a carboxylic acid group (—COOH), sulfonic acid group (—SO₃H) and phosphorous acid group (—PO₃H₂) or metallic salt thereof. The modification time and naming of the separators of Preparation example 1 and Preparation example 2 are shown in Table 1 below.

TABLE 1

| Sample name | Modification time |
|---|---|
| PFM | 0 minute |
| mPFM5 | 5 minutes |
| mPFM10 | 10 minutes |
| mPFM15 | 15 minutes |
| mPFM30 | 30 minutes |

It should be understood that the surface modification using the lithium hydroxide aqueous solution in the present preparation example is only an example, a person having ordinarily knowledge in the art of the present disclosure may use other alkaline aqueous solutions (e.g., sodium hydroxide aqueous solution) as needed for modification, or use other surface modification technologies (e.g., plasma, ozone and other technologies) for modification. In addition, the present technology can also obtain functional groups with the same effect through polymer mixing.

### Preparation Example 3-1: Preparation of Gel Polymer Electrolyte (GPE) Precursor Solution

1. Preparation of synthetic dimethacrylate (SDMA) crosslinker: First, the monomer glycidyl methacrylate (GMA) and polyetherdiamine are placed in the reaction bottle at 2:1 molar ratio, and stirred and heated through the 60° C. oil bath pot for 24 hours, the epoxy group on the GMA and the diamine group of polyetherdiamine (Mn˜2000) are used to undergo an epoxy ring-opening reaction for preparing synthetic dimethacrylate (SDMA) with acrylic groups at two ends as a crosslinker. After the reaction is completed, the product is reconstituted in an appropriate amount of tetrahydrofuran (THF) and then re-precipitated with n-hexane to remove the leftovers and impurities, and finally the purified polymer is placed in a vacuum oven at room temperature to dry for 6 hours to remove the residual solvent.

2. Preparation of gel polymer electrolyte precursor solution (using azo-type initiator): SDMA crosslinker and poly (ethylene glycol) methyl ether methacrylate (PEGMEMA) are mixed evenly, until it is homogenized into a phase, a initiator azobisisobutyronitrile (AIBN, an azo-type initiator) is added. The mixture is heated to 55° C. and stirred until AIBN dissolved, the resulting polymer mixture is placed in the glove box to mix with liquid electrolytes having different lithium salt concentrations, and the gel polymer electrolyte precursor solution of the present preparation example can be obtained after complete dissolution.

Preparation example 3-2: preparation of gel polymer electrolyte (GPE) precursor solution

1. Preparation of synthetic dimethacrylate (SDMA) crosslinker: First, the monomer glycidyl methacrylate (GMA) and polyetherdiamine are placed in the reaction bottle at 2:1 molar ratio, and stirred and heated through the 60° C. oil bath pot for 24 hours, the epoxy group on the GMA and the diamine group of polyetherdiamine (Mn˜2000) are used to undergo an epoxy ring-opening reaction for preparing synthetic dimethacrylate (SDMA) with acrylic groups at two ends as a crosslinker. After the reaction is completed, the product is reconstituted in an appropriate amount of tetrahydrofuran (THF) and then re-precipitated with n-hexane to remove the leftovers and impurities, and finally the purified polymer is placed in a vacuum oven at room temperature to dry for 6 hours to remove the residual solvent.

2. Preparation of gel polymer electrolyte precursor solution (using peroxide-type initiator): SDMA crosslinker and poly (ethylene glycol) methyl ether methacrylate (PEGMEMA) are mixed evenly, until it is homogenized into a phase, Luperox 231 (a peroxide-type initiator) is added. The mixture is heated to 55° C. and stirred until Luperox 231 dissolved, the resulting polymer mixture is placed in the glove box to mix with liquid electrolytes having different lithium salt concentrations, and the gel polymer electrolyte precursor solution of the present preparation example can be obtained after complete dissolution.

The gel polymer electrolyte precursor solution of Preparation example 3-1 and 3-2 comprises: synthetic dimethacrylate (SDMA) with acrylic groups at two ends, poly (ethylene glycol) methyl ether methacrylate (PEGMEMA), azobisisobutyronitrile (AIBN, an azo-type initiator) or Luperox 231 (a peroxide-type initiator), and lithium salts. However the present invention is not limited thereto, other multi-functional methacrylate crosslinkers known in the art may be used instead of synthetic dimethacrylate (SDMA) with acrylic groups at two ends; other poly (ethylene glycol)-based methacrylates known in the art may be used instead of poly (ethylene glycol) methyl ether methacrylate (PEGMEMA), more specifically the above-mentioned poly (ethylene glycol)-based methacrylates may be poly (ethylene glycol)-based mono-functional methacrylate or poly (ethylene glycol)-based multi-functional methacrylate; other azo-type initiators or peroxide-type initiators known in the art may be used instead of azobisisobutyronitrile (AIBN), more specifically the above-mentioned azo-type initiator may be selected from the group consisting of 2,2′-Azobisisobutyronitrile (AIBN), 2,2′-Azobis(2,4-dimethyl)valeronitrile (ADVN), 2,2′-Azobis-(2-methybutyronitrile) (AMBN), and 4,4 -Azobis(4-cyanovaleric acid) (ACVA); and the gel polymer electrolyte precursor solution may not contain a lithium salt.

Preparation example 3-1 and 3-2 using an azo-type initiator and a peroxide-type initiator respectively, and both resulted in fully gelled polymer electrolyte by heating to 55° C. However the present invention is not limited thereto, other thermal initiators known in the art may be used instead of azo-type initiators and peroxide-type initiators.

In some embodiments, using peroxide-type initiators instead of azo-type initiators may have better results.

Preparation example 4: preparation of solid polymer electrolyte (mPNWM)

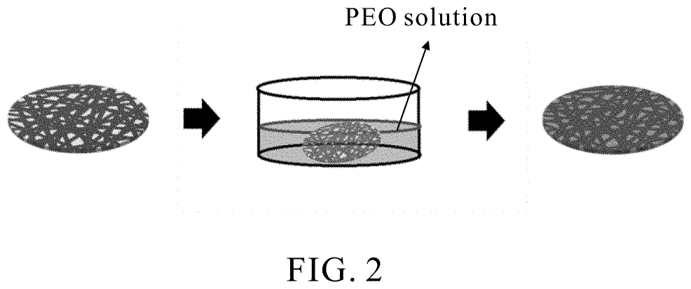

The preparation process of Preparation example 4 is shown in FIG. 2, the polymer poly (ethylene oxide) (PEO) of 1 million molecular weights and lithium salt in accordance with the weight ratio of 54:46 are dissolved in methanol solution, the temperature is slightly raised, so that the polymer and lithium salt are completely dissolved in the solvent, and then the electrospinning fibrous membranes with different degrees of modification completed by Preparation example 2 are soaked in the polymer solution, taken out and placed on the heating plate setting the temperature of 60° C., after heating overnight, the resulting solid electrolyte membranes are placed into a vacuum oven to ensure that the solvent is completely removed to form solid polymer electrolytes of the present embodiment, and finally they are stored in a glove box. The solid electrolytes with the modified fibrous membranes are named mPNWM.

### Comparative Preparation Example 1: Preparation of Solid Polymer Electrolyte (PNWM)

The preparation process of Comparative preparation example 1 is basically the same as that of Preparation example 1, the difference is only in the use of the unmodified electrospinning fibrous membrane of Preparation example 1 instead of the modified electrospinning fibrous membrane of Preparation example 1. The solid electrolyte with the unmodified fibrous membrane is named PNWM.

### Example 1: Button Cell Battery Applying a Gel Electrolyte

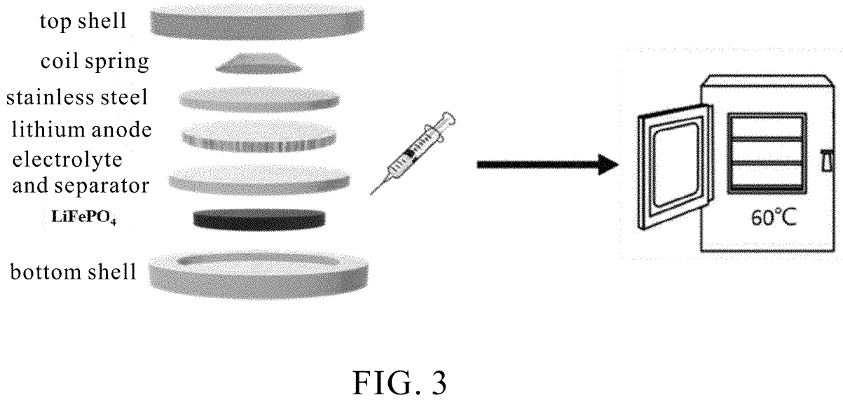

The preparation process of Example 1 is shown in FIG. 3, with lithium iron phosphate (LiFePO₄) pole piece as the positive electrode, lithium metal as the negative electrode, the modified electrospinning fibrous membrane of Preparation example 2 as a separator, the gel polymer electrolyte precursor solution of Preparation example 4 is injected, so that it is cladded on the separator, and the button cell battery of model CR2032 is assembled in a glove box of an argon environment, as shown in FIG. 3, and then the battery sealer is used to press each component into a tablet to ensure battery sealing. Finally, the assembled button cell battery is placed in a 60° C. oven for 2 hours to carry out a crosslinking reaction so that the gel polymer electrolyte precursor solution of Preparation example 4 forms a gel polymer electrolyte.

### Example 2: Button Cell Battery Applying a Solid Electrolyte

The preparation process of Example 2 is basically the same as that of Example 1, the difference is only in the use of the solid polymer electrolyte of Preparation example 4 instead of the electrospinning fibrous membrane and the gel polymer electrolyte precursor solution of Example 1.

### Comparative Example 1

The preparation process of Comparative example 1 is basically the same as that of Example 1, the difference is only in the use of the unmodified electro spinning fibrous membrane of Preparation example 1 instead of the modified electrospinning fibrous membrane.

### Comparative Example 2

The preparation process of Comparative example 2 is basically the same as that of Example 1, the difference is only in the use of the commercial three-layer (PP/PE/PP) porous membrane instead of the modified electrospinning fibrous membrane.

### Comparative Example 3

The preparation process of Comparative example 3 is basically the same as that of Example 2, the difference is only in the use of the solid polymer electrolyte (PNWM) of Comparative preparation example 1 instead of the solid polymer electrolyte (mPNWM).

### Test Example 1: Scanning Electron Microscope (SEM)

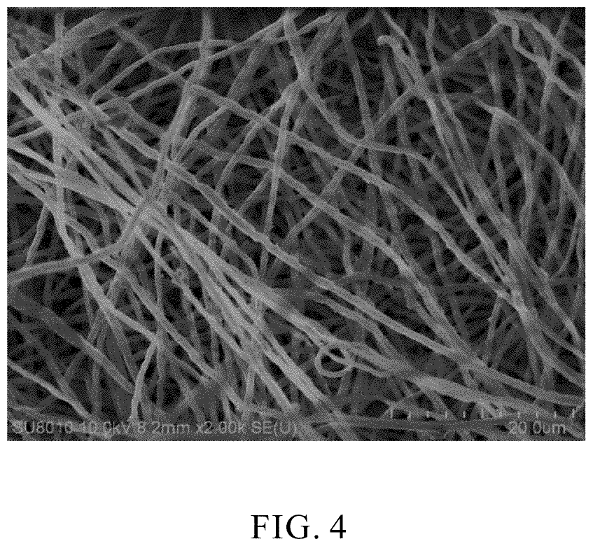

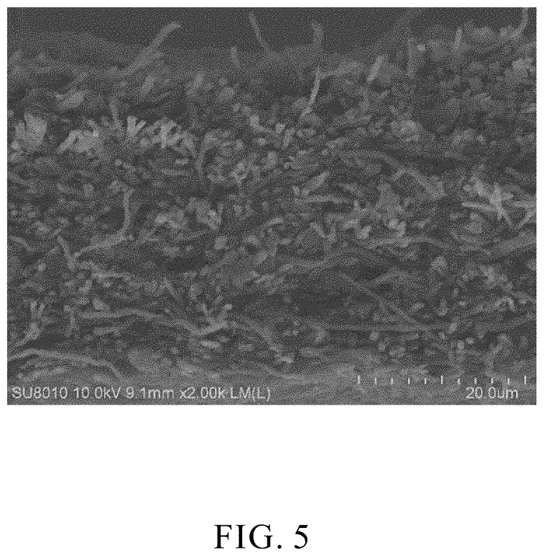

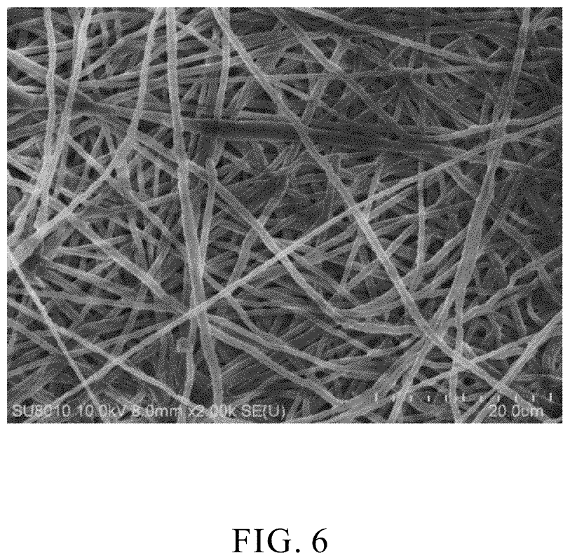

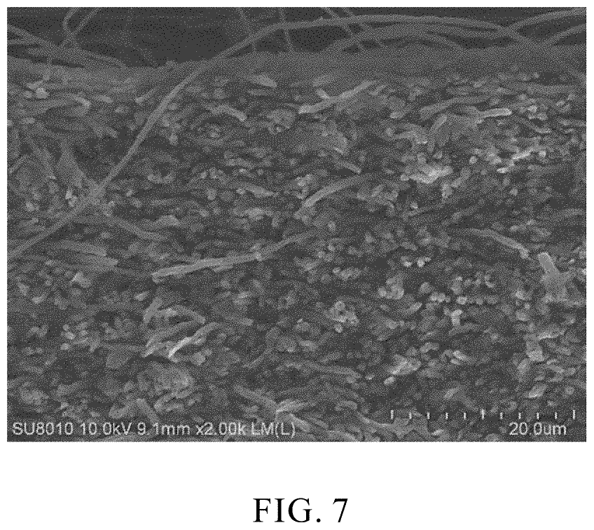

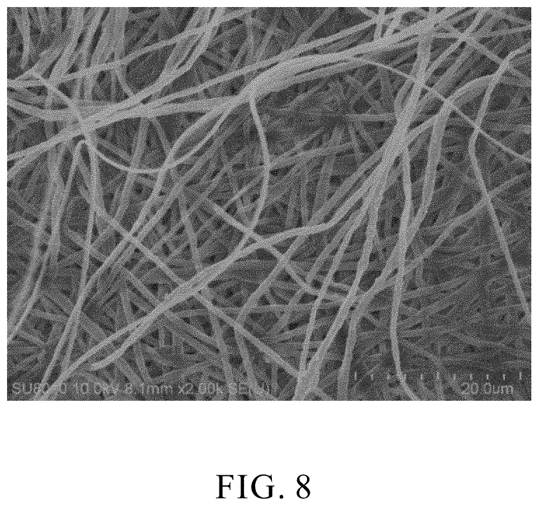

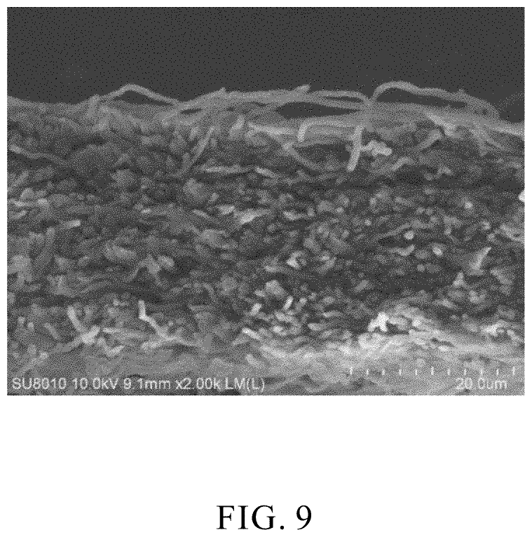

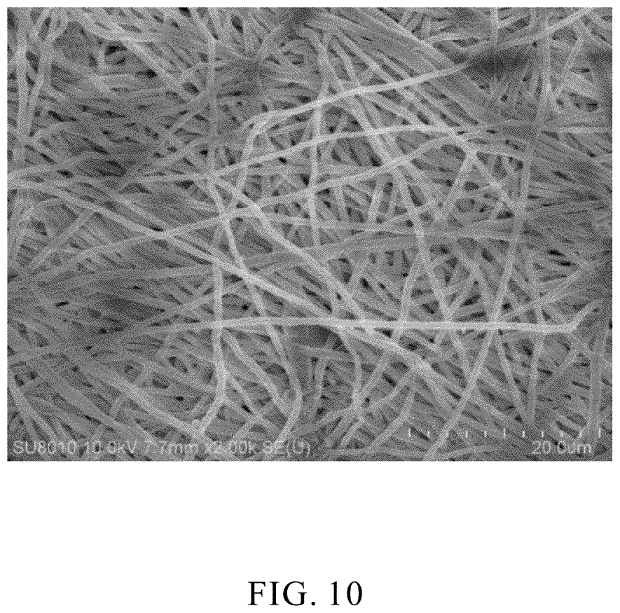

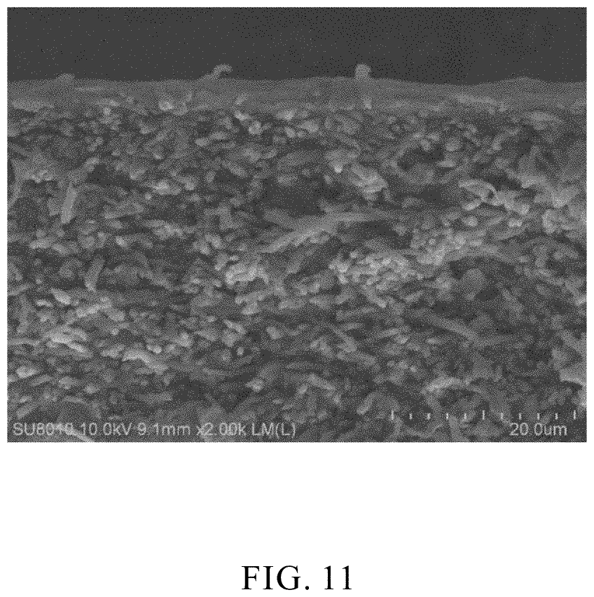

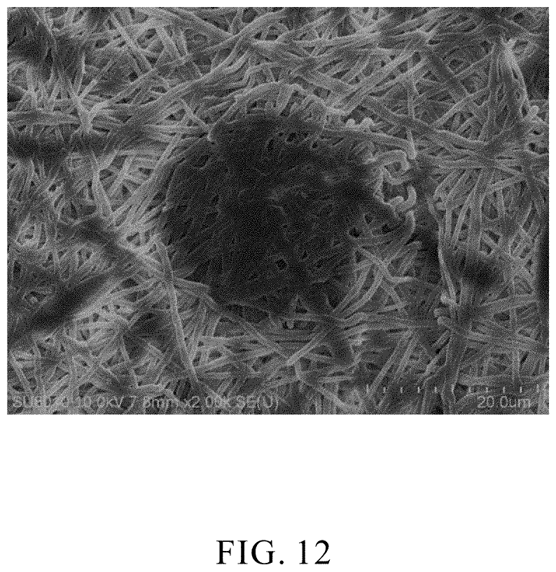

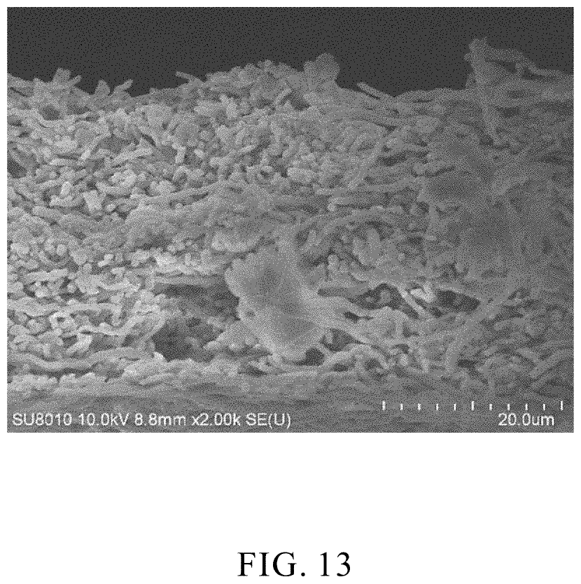

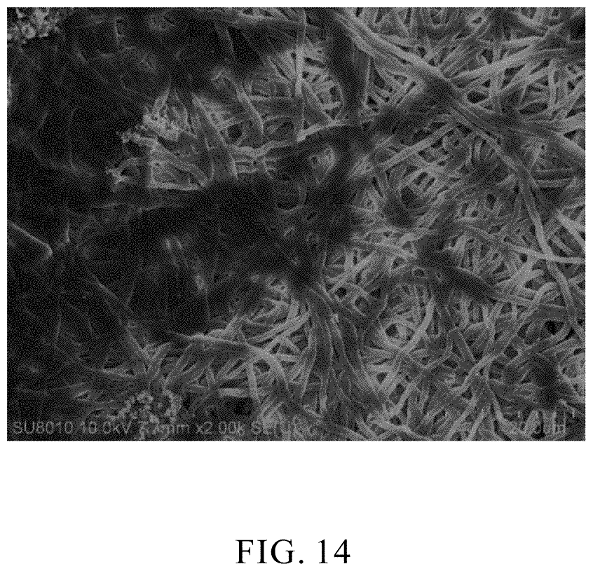

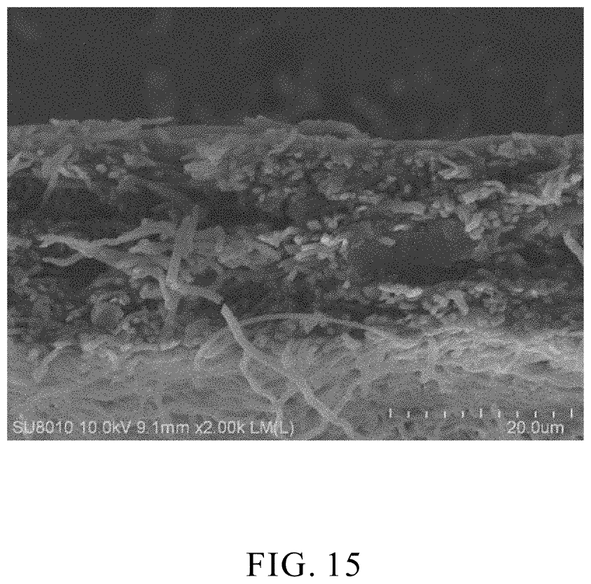

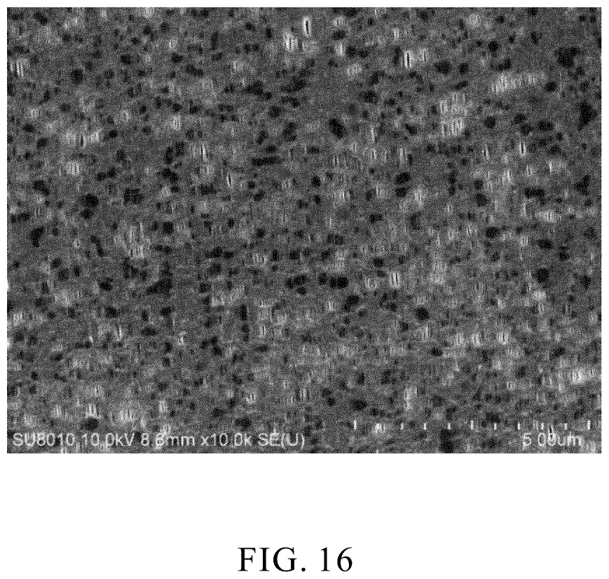

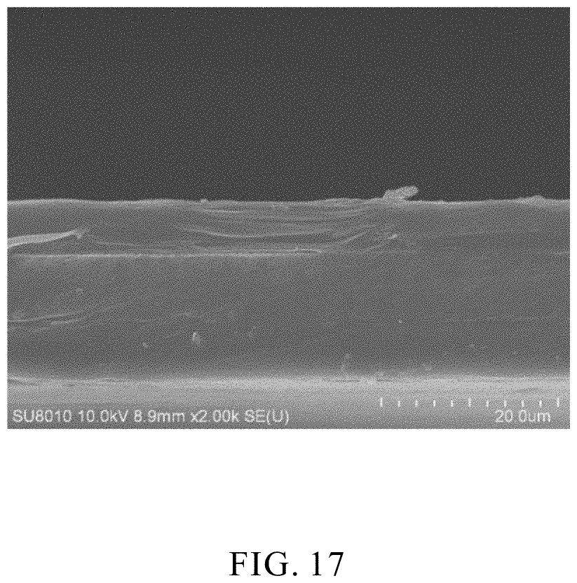

In order to explore the surface structure and pattern of fibrous membrane with different degrees of modification, the present test example uses SEM electron microscopy to respectively shoot the surfaces and cross-sections of the fibrous membranes of mPFM 5, mPFM 15, mPFM 30, mPFM 60 and mPFM 120 at a magnification of 2 k, and shoots the unmodified fibrous membrane PFM and the commercial three-layer (PP/PE/PP) porous membrane as contrast, and the results are shown in FIGS. 4 to 17.

### Test Example 2: Measurement and Calculation of Porosity

First, the dry membrane weight of the electrospinning fibrous membrane is weighed, and then it is soaked in a certain amount of n-butanol for one hour, and then it is taken out to dry the residual n-butanol on the surface. The weight of the membrane after infiltration is then weighed and the porosity is calculated using the following formula.

$$Porosity ( \% ) = \frac{\frac{{m}_{a}}{{ρ}_{a}}}{\frac{{m}_{a}}{{ρ}_{a}} + \frac{{m}_{b}}{{ρ}_{b}}} \times 100$$

mₐ is the membrane weight after infiltration (g); m_{b} is the dry membrane weight (g);

ρₐ is the density of n-butanol (g cm⁻²); ρ_{b} is the density of the electrospinning fibrous membrane (g cm⁻²)

The porosity of the separator is a critical influencing factor in battery performance, and the higher porosity the separator has, the more electrolyte can be absorbed, so that the ions can migrate more smoothly. In order to understand the porosity of the separator contained in the energy storage device of the present disclosure, the different separators are soaked in n-butanol, and the porosity is calculated by the weight formula with measuring the membrane weight before and after wetting, the results are shown in Table 2 below.

### Test Example 3: Measurement and Calculation of Ionic Conductivity

TABLE 2

| Sample | Porosity (%) |
|---|---|
| PP/PE/PP | 42.0 |
| PFM | 81.2 |
| mPFM5 | 81.4 |
| mPFM15 | 81.1 |
| mPFM30 | 79.9 |
| mPFM60 | 76.9 |
| mPFM120 | 75.8 |

### Test Example 3: Measurement and Calculation of Ionic Conductivity

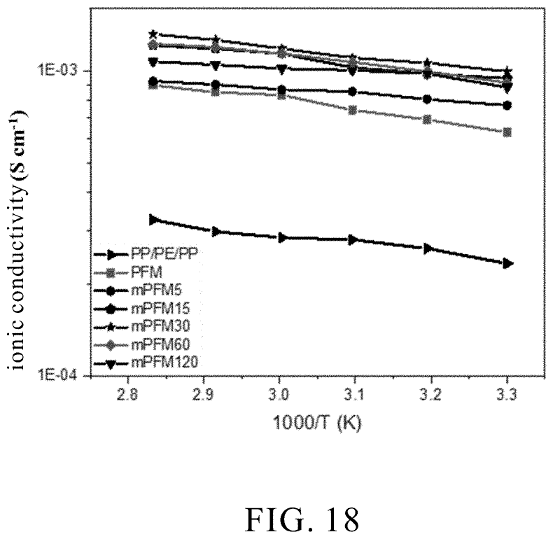

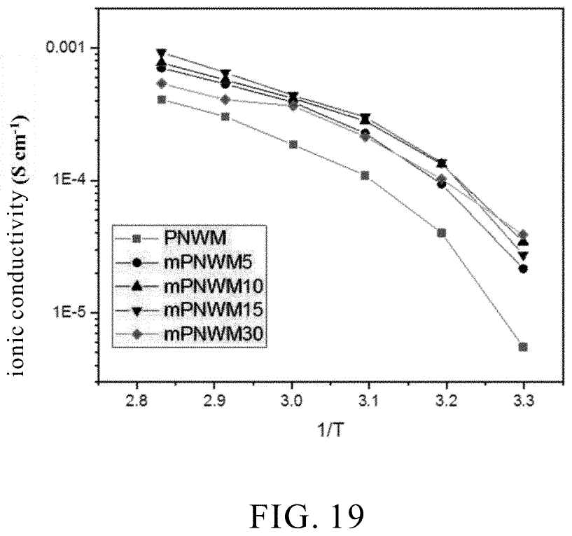

The ionic conductivity test is the use of inert stainless steel as an electrode, because the inert electrode is less likely to occur interface reaction, the charge transfer impedance is small, in the general AC impedance spectroscopy can only obtain a positive slope straight line across the real axis, that is, the total resistance value R_{b}. The ionic conductivity a (S cm⁻¹) of the sample can be obtained by using the following formula, and the test results are shown in FIGS. 18 to 19.

$$σ = \frac{L}{{R}_{b} \times A}$$

L is the membrane thickness of the separator (cm), A is the circular area of the stainless-steel gasket (cm²)

The ionic conductivity of the commercial separator (PP/PE/PP) is largely different from that of the electrospinning fibrous membranes (PFM and mPFM) of the preparation example 1 and the preparation example 2, it is speculated that the structure of the electrospinning fibrous membrane itself is an ionic conductive polymer and it has a higher porosity so that the ions have more conduction paths and can increase the ionic conductivity, compared with the commercial separator.

### Test Example 4: Battery Performance Test-1 (C-Rate Test)

A button type half-cell of model CR2032 is assembled with LiFePO₄ pole piece as the positive electrode, lithium metal as the negative electrode, electrolyte as the traditional liquid polymer electrolyte (ethylene carbonate (EC)/dimethylene carbonate (DMC) 1:1 vol. %, 1M LiPF₆) and mPFM 30 separator, the assembled battery is connected to the BAT-705B automatic charge and discharge tester, the test cut-off voltage range is set from 2.5 V to 4.0 V, the charging rate is fixed at 0.1 C, and the discharging rate is 0.1 C, 0.5 C, 1 C, 3 C, 5 C, 7 C and 10 C, respectively. After the setting is completed, the battery is placed at room temperature for charge and discharge test, and the capacitance values of different charge and discharge rates at room temperature can be obtained.

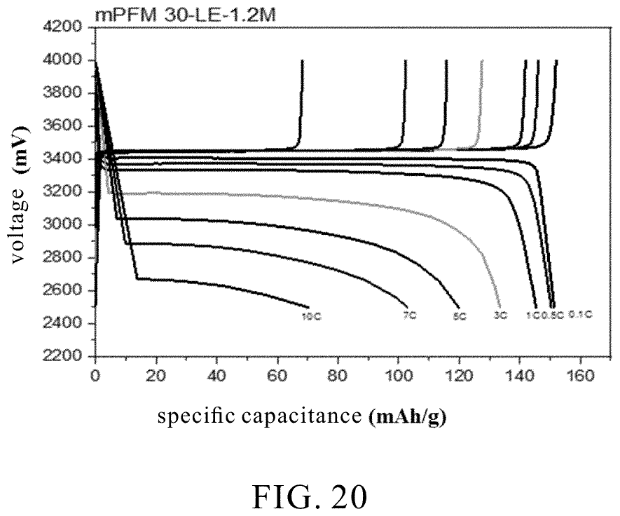

The present test example uses LiFePO₄|LE|Li button type half-cell composed of the mPFM 30 separator to be tested for battery performance at room temperature, thereby analyzing the actual application of mPFM 30 separator to liquid lithium batteries, and the test results are shown in FIG. 20.

### Test Example 5: Battery Performance Test-2 (C-Rate Test)

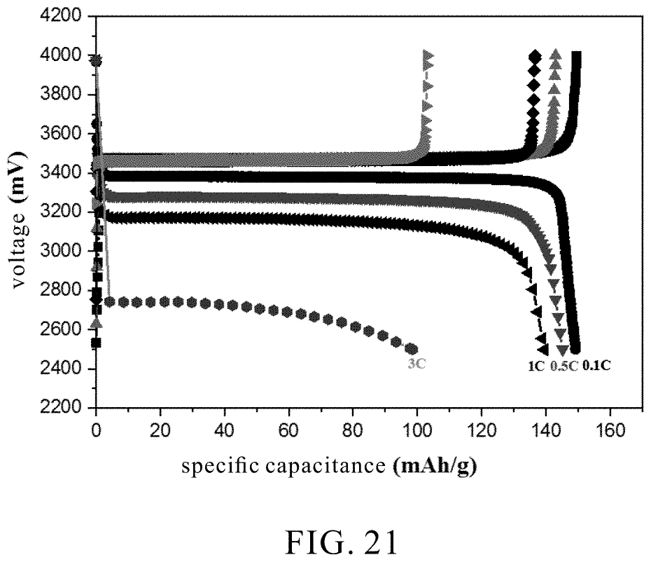

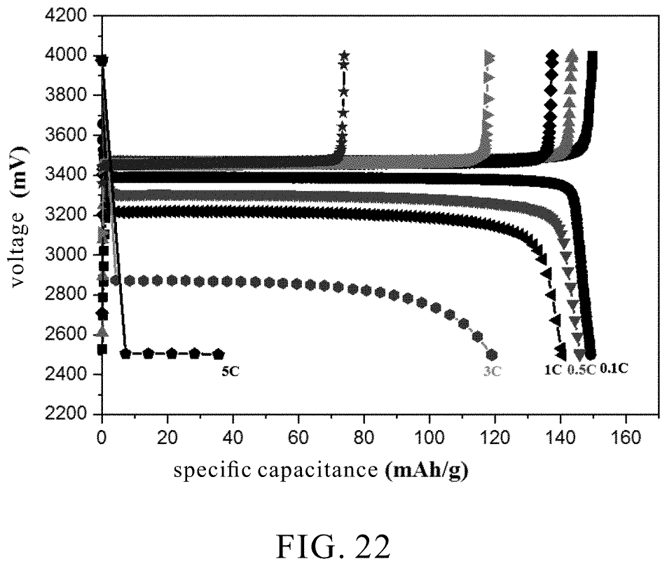

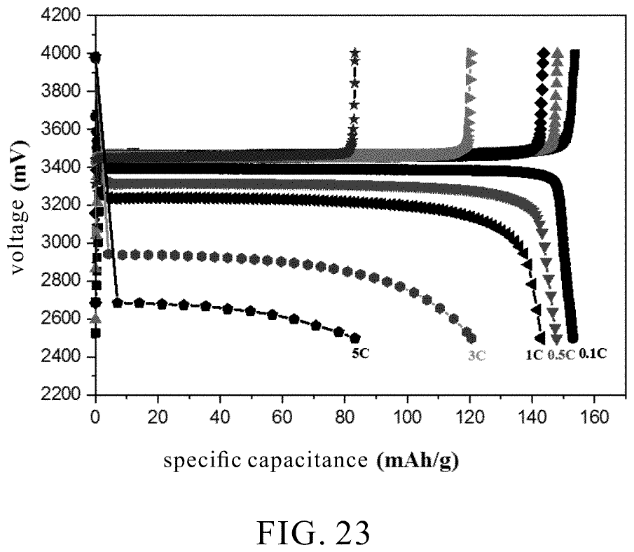

The test process of Test example 5 is basically the same as that of Test example 4, and the difference is only that in the present test example, the gel polymer electrolyte (GPE) of Preparation example 3 is used, LiFePO₄|GPE|Li button type half-cells composed of the different separators are tested for battery performance at room temperature, thereby analyzing the actual application of the different separators to lithium batteries, and the test results are shown in FIGS. 21 to 23 and Table 3.

TABLE 3

| Sample | 0.1 C | 0.5 C | 1 C | 3 C | 5 C |
|---|---|---|---|---|---|
| PP/PE/PP | 149.2 | 145.2 | 139.4 | 98.5 | X |
| (Comparative | | | | | |
| example 2) | | | | | |
| PFM | 149.2 | 145.8 | 140.5 | 119 | 35.6 |
| (Comparative | | | | | |
| example 1) | | | | | |
| mPFM 30 | 153 | 147.8 | 142.9 | 120.5 | 83.1 |

### Test Example 6: Battery Performance Test-3 (C-Rate Test)

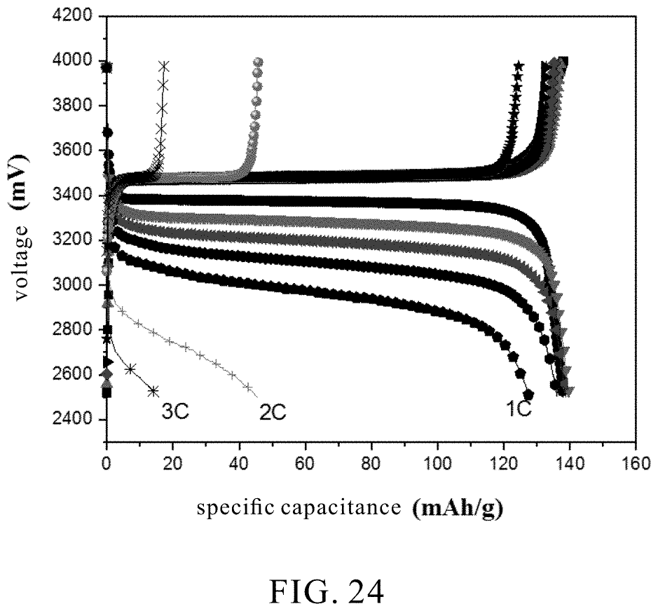

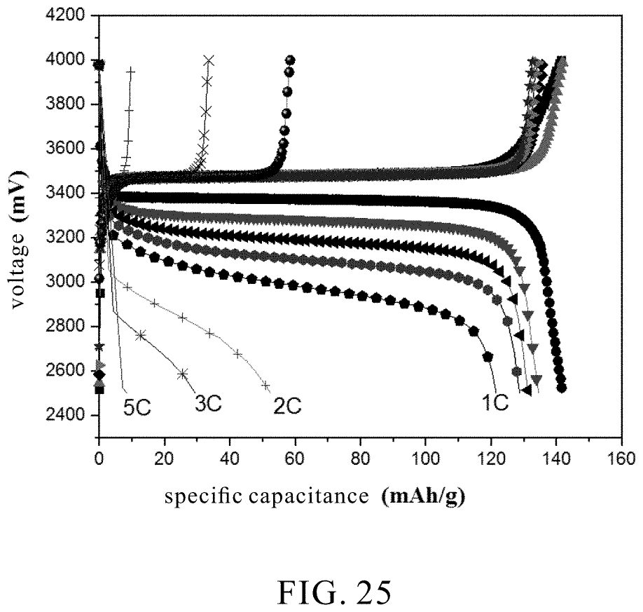

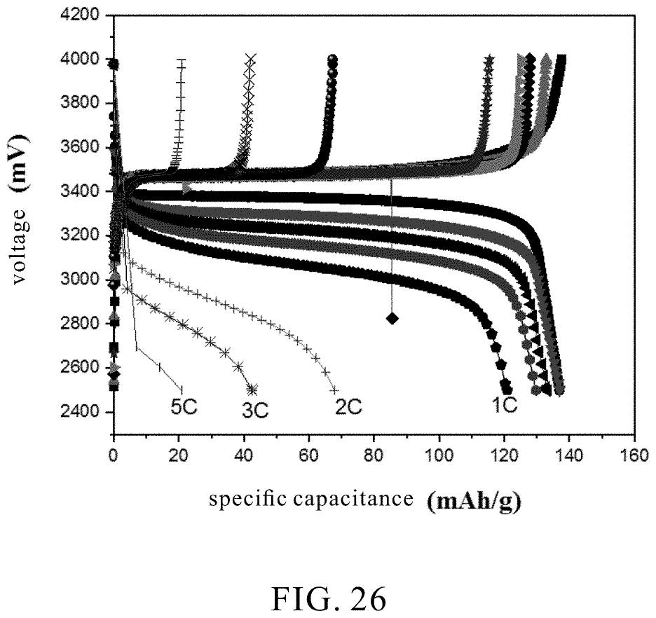

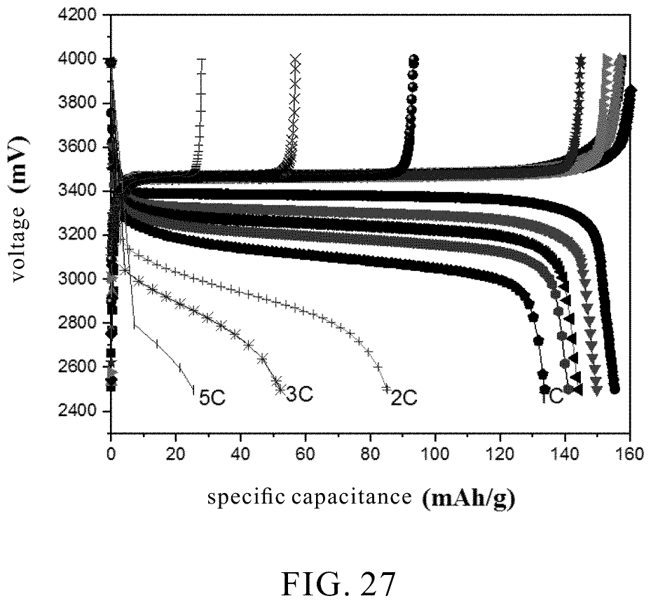

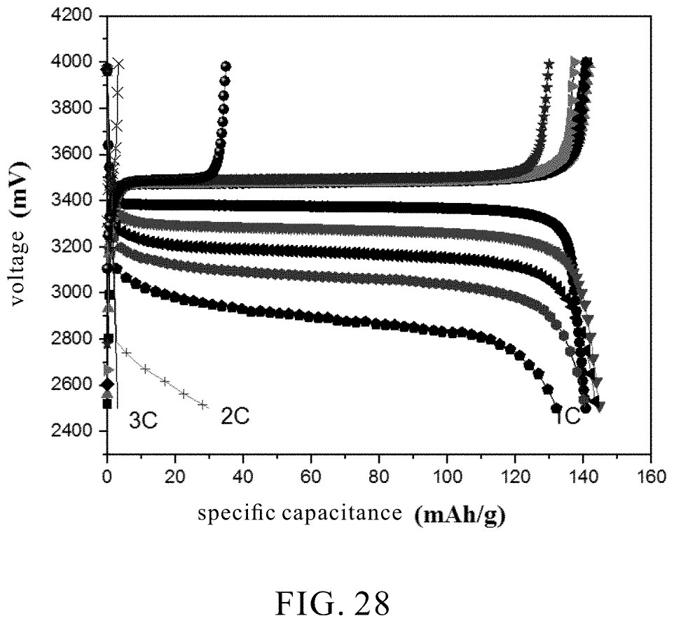

The test process of Test example 6 is basically the same as that of Test example 4, and the difference is only that in the present test example, the solid polymer electrolyte (mPNWM) of Preparation example 4 is used, LiFePO₄|solid polymer electrolyte |Li button type half-cells composed of the different separators to be tested for battery performance at room temperature, thereby analyzing the actual application of the different separators to lithium batteries, and the test results are shown in FIGS. 24 to 28 and Table 4.

TABLE 4

| | 1C | 2C | 3C | 5C |
|---|---|---|---|---|
| PNWM | 127.7 | 45.5 | 15.9 | X |
| (Comparative | | | | |
| example 3) | | | | |
| mPNWM5 | 121.6 | 52.5 | 29.5 | 8.6 |
| mPNWM10 | 120.9 | 67.9 | 42.6 | 20.8 |
| mPNWM15 | 133.8 | 85.2 | 52.2 | 25.5 |
| mPNWM30 | 132.1 | 29.4 | 3.08 | X |

### Test Example 7: Cycle Life Test-1 of Battery

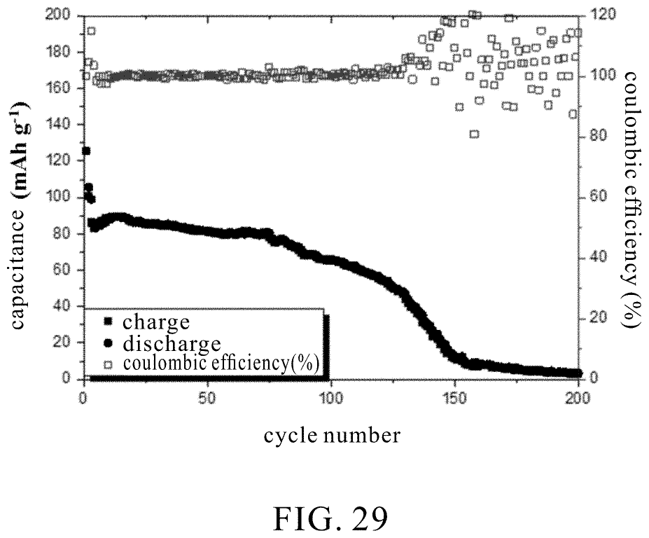

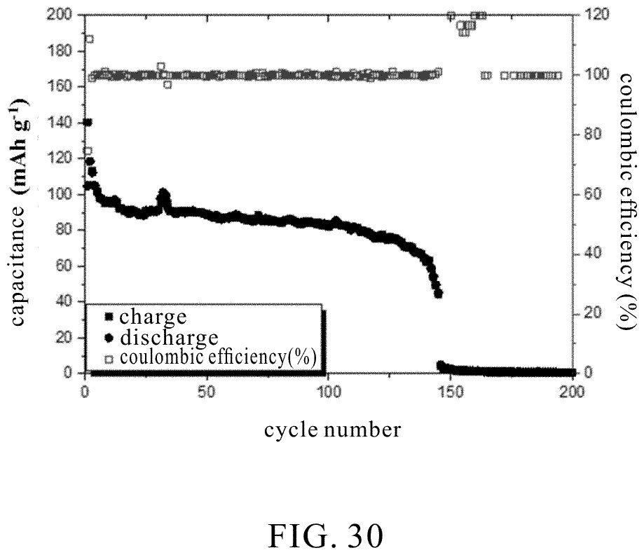

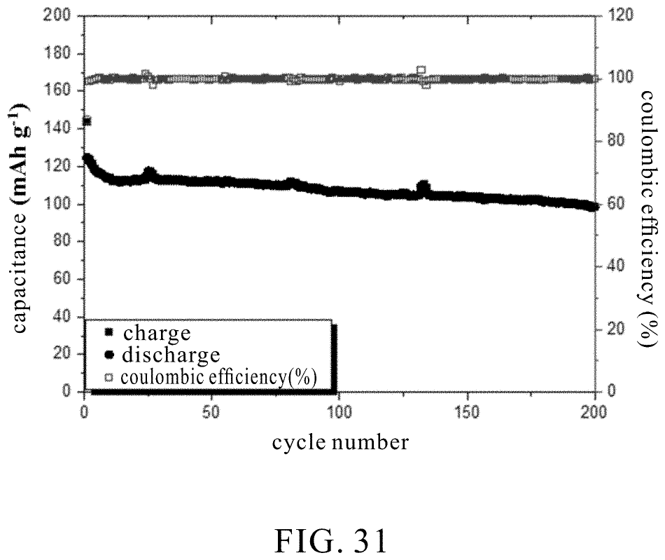

The different separators are used to constitute CR2032 button type half-cells of LiFePO₄|GPE|Li, the assembled battery is connected to the BAT-705B automatic charge and discharge tester, the test cut-off voltage range is set from 2.5 V to 4.0 V, the cyclic charge and discharge test is carried out by a rate fixed at 2C, it can be observed that the capacitance decline rate and cycle life of the battery after a long period of charge and discharge, the test results are shown in FIGS. 29 to 31.

From FIGS. 29 to 31, it can be clearly observed that when a commercial three-layer (PP/PE/PP) porous membrane is used as a separator, the capacitance has gradually declined since the beginning, and the capacitance maintenance rate at the 100th turn is only 52%. In contrast, the capacitance maintenance rates of PFM and mPFM 30 at 100 turns are much greater than that of PP/PE/PP, and until the cycle reaches 150 turns, the capacitance maintenance rate of mPFM 30 still remains 83.1%, far exceeding PFM and PP/PE/PP.

### Test Example 8: Cycle Life Test-2 of Battery

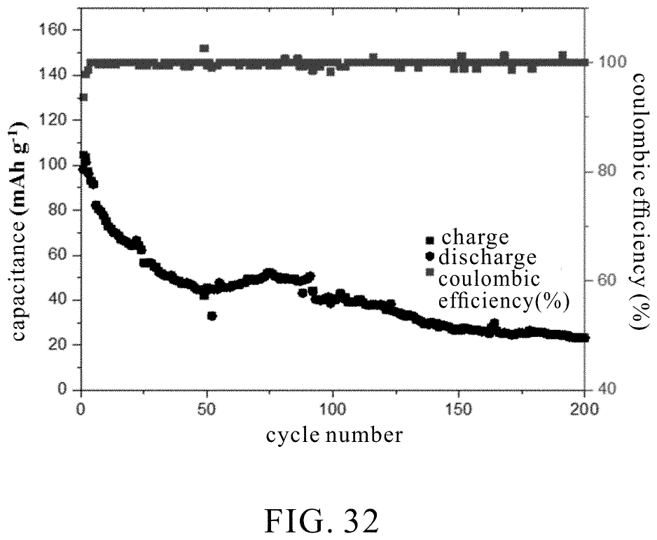

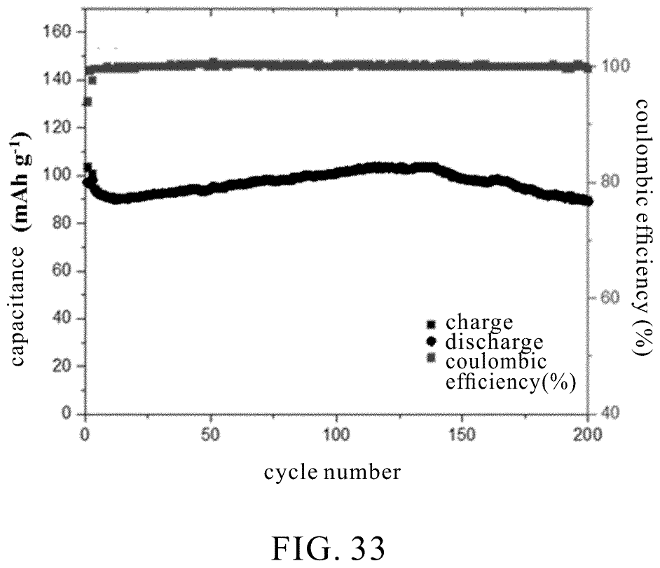

The CR2032 button type half-cells of LiFePO₄|solid polymer electrolyte|Li composed of a solid polymer electrolyte (PNWM) comprising an unmodified PFM and the solid polymer electrolyte (mPNWM15) that has the best performance in Test example 6 are used to carry out the cyclic charge and discharge test at a rate of 1C at 60° C., the results are shown in FIGS. 32 to 33.

As can be seen from FIGS. 32 to 33, the capacitance of the unmodified PNWM declines significantly since the beginning, and the capacitance maintenance rate is only 23.6% after 200 turns, in contrast, the capacitance maintenance rate of mPNWM15 still remains 91.8% after the cyclic charge and discharge of 200 turns.

### Test Example 9: Cycle Life Test-3 of Battery

The test example mixes acrylonitrile with sulfonated polystyrene monomer at a weight ratio of 97:3, and adds azobisisobutyronitrile (AIBN) of 0.1 percent by weight in dimethyl sulfoxide (DMSO) at 65° C. for polymerization, and then carries out reprecipitation in water to obtain polyacrylonitrile copolymer (Co-polymer A).

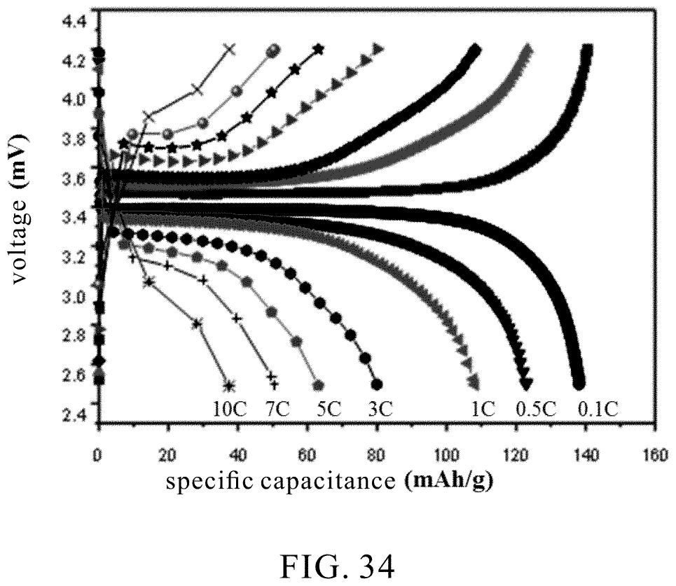

Co-polymer A is electrospinned with the same preparation steps of Preparation example 1, a separator is prepared and LiFePO₄|LE|Li button type half-cell is constituted and carried out the battery performance test at room temperature, thereby analyzing the actual application of the fibrous membrane to liquid lithium batteries, and the test results are shown in the following Table 5 and FIG. 34.

TABLE 5

| | 0.1 C | 0.5 C | 1 C | 3 C | 5 C |
|---|---|---|---|---|---|
| Co-Polymer A | 138 | 123 | 108 | 80 | 63 |

In summary, the energy storage device of the disclosure may have preferable battery performance and cycle life by the technical feature of “a fibrous membrane composed of polyacrylonitrile is used as a separator, and a surface of the fibrous membrane is modified by an acidic functional group or a salt thereof”.

The above embodiments of the disclosure made only by way of example to describe the feature and effect of the disclosure, and it should not be considered as the scope of substantial technical content is limited thereby. Various possible modifications and alternations of the embodiments could be carried out by the those of ordinary skill in the art without departing from the spirit and scope of the disclosure. Therefore, the scope of the disclosure is based on the appended claims.

What is claimed is:

1. An energy storage device, comprising:
an anode;
a cathode;
a separator, which is located between the anode and the cathode;
an electrolyte, which is disposed between the anode and the cathode, and cladded on the separator;
wherein, the separator is a fibrous membrane composed of polyacrylonitrile, and a surface of the fibrous membrane is modified by an acidic functional group or a salt thereof.

2. The energy storage device according to claim 1, wherein the acidic functional group is selected from the group consisting of carboxylic acid group (—COOH), sulfonic acid group (—SO₃H), sulfuric acid group (—OSO₃H), phosphoric acid group (—OPO₃H₂), phosphorous acid group (—PO₃H₂) and carbonic acid group (—OCO₂H).

3. The energy storage device according to claim 1, wherein the salt is selected from the group consisting of lithium salt, sodium salt, potassium salt, magnesium salt, calcium salt, aluminum salt and quaternary ammonium salt.

4. The energy storage device according to claim 1, wherein the fibrous membrane is obtained by an electrospinning process or a meltblown process.

5. The energy storage device according to claim 1, wherein the electrolyte is a liquid, gel or solid substance that can conduct lithium ions.

6. The energy storage device according to claim 1, wherein the electrolyte is a gel substance that can conduct lithium ions, and the gel substance is derived from a gel polymer electrolyte precursor solution, the gel polymer electrolyte precursor solution comprises: a multi-functional methacrylate crosslinker, a poly (ethylene glycol)-based methacrylate, and an azo-type initiator or a peroxide-type initiator.

7. The energy storage device according to claim 6, wherein the azo-type initiator is selected from the group consisting of 2,2′-Azobisisobutyronitrile (AIBN), 2,2′-Azobis(2,4-dimethyl)valeronitrile (ADVN), 2,2′-Azobis-(2-methybutyronitrile) (AMBN), and 4,4 -Azobis(4-cyanovaleric acid) (ACVA).

8. The energy storage device according to claim 1, wherein the electrolyte is a solid substance that can conduct lithium ions, and the separator is cladded in the solid substance to form a solid polymer electrolyte.

9. The energy storage device according to claim 8, wherein the solid substance is formed by a mixture of poly(ethylene oxide) (PEO) and lithium salts after solidification.
